(19) United States
(12) Patent Application Publication
(10) Pub. No.: US 2007/0057495 A1
(43) Pub. Date: Mar. 15, 2007

(54) Side airbag module and method of manufacture

(76) Inventors: Todd E. Tesch, Tipp City, OH (US); Rhoel S. Ramos, Kettering, OH (US)

Correspondence Address: DELPHI TECHNOLOGIES, INC., M/C 480-410-202, PO BOX 5052, TROY, MI, 48007, US

(21) Appl. No.: 11/229,329

(22) Filed: Sep. 16, 2005

Related U.S. Application Data
(60) Provisional application No. 60/717,309, filed on Sep. 15, 2005.

(51) Int. Cl. B60R 21/26

(52) U.S. Cl. 280/736

(57) ABSTRACT

An airbag module for deploying an inflatable cushion along an interior side of a vehicle, the airbag module comprising: a first inflatable cushion providing a first inflatable portion when inflated; an inflator for providing an inflation force to the first inflatable cushion in accordance with a predetermined activation event; and a fluid dispersing conduit for providing the inflation force to the first inflatable cushion, the fluid dispersing conduit being in fluid communication with the first inflatable cushion and the inflator wherein the fluid dispersing conduit comprises a portion disposed between the inflator and the first inflatable cushion, wherein the portion provides a means for increasing an inflatable coverage of the airbag module by providing an area disposed between the first inflatable cushion and the inflator, wherein the area is capable of being converted into a diffuser opening for a second inflatable cushion, wherein the second inflatable cushion is inflated by the inflation force and the second inflatable cushion provides a second inflatable portion when inflated, the second inflatable portion being smaller than the first inflatable portion.

### CROSS REFERENCE TO RELATED APPLICATIONS

This application claims the benefit of United States Provisional Application, Serial No. ______, (Express Mail Label No. EV703403250US), attorney docket no. DP-314113, filed Sep. 15, 2005 the contents of which are incorporated herein by reference thereto.

### TECHNICAL FIELD

The present invention relates to side airbag devices and more particularly the present invention relates to an inflatable cushion and method of manufacture.

### BACKGROUND

Some vehicles are supplied with side airbag devices or side airbag curtains. Generally the device is located along a side of the vehicle and deploys an inflatable curtain in accordance with a predetermined activation occurrence. The side impact airbags or inflatable cushions are often mounted in close proximity to the vehicle's roof rail, doorframe or center pillars, or in some instances within the side door. Accordingly, the space or housing for the un-inflated airbag is compact and extends or traverses along the window area or frame, as the airbag cannot be installed in the areas comprising the window. Moreover, it is also desirable to have the inflatable cushion disposed behind a decorative trim portion of the vehicle's interior. Thus, the presence of the side airbag device is not observable to occupants when it is in its un-deployed state.

When the airbag or inflatable cushion is mounted to the vehicle the top edge portion is fixed and a lower edge portion, which defines the bottom periphery of the airbag, deploys out of the storage location positioned in close proximity to the roof rail. Furthermore, and referring in particular to larger or longer vehicles (e.g., sports utility vehicles, vans, mini-vans, station wagons, etc.) a single side airbag or inflatable cushion that extends from the A pillar to the D pillar, or further, of the vehicle has to have an extended length to cover the side areas of the vehicle. Accordingly, these extended inflatable cushions require additional inflator output in order to inflate and maintain the inflation of the cushion for a pre-determined period of time.

In addition, and due to the location of deployment of these cushions (e.g., vehicle side, A-D pillars) it is desirable to provide these cushions with an extended period of inflation. Moreover, and depending on the vehicle type other areas of the cushion that traverse across the interior of the vehicle (e.g., between doors) may not require inflation. However, these areas still comprise a portion of the inflatable cushion. The required extended period of inflation may comprise up to and exceed five seconds. These extended periods of inflation allow the inflatable cushion to provide a retentive barrier across the opening of the windows of the vehicle. In order to provide inflation cushions which retain their inflation gases for extended periods of time the cushion is in one configuration provided with sealed seams in accordance with the teachings of U.S. Pat. No. 6,220,309, the contents of which are incorporated herein by reference thereto. Alternatively, sealed cushions are provided by disposing sealing material such as silicone between the edges of two sheets of fabric members comprising the inflatable cushion. In addition, these types of cushions (e.g., less permeable cushions or cushions that retain inflation gases for extended periods of time) are expensive to manufacture. Accordingly and as side impact inflation cushions become larger in order to cover extended lengths and areas their associated costs increase.

Alternatively, a plurality of cushions may be provided each having a separate inflator and installation location, which will result in additional costs. Moreover, usage of multiple cushions with additional inflators will result the requirement of addition space behind the interior trim as well as associated manufacturing costs for multiple installation locations.

Accordingly, it is desirable to provide a cost-efficient side airbag module wherein a plurality of separate inflatable cushions are provided without the associated costs. In addition, it is also desirable to provide a side airbag module with a securement method or apparatus that limits the amount of components (e.g., reducing cost) as well as providing a rigid means for securing the same to the vehicle.

### SUMMARY OF THE INVENTION

This disclosure relates to a side airbag and method of making. In an exemplary embodiment, a side airbag module is provide wherein the module is capable of providing multiple inflatable cushion configurations while using a single inflator is provided.

In one exemplary embodiment an airbag module is provided. The airbag module comprising: a first inflatable cushion providing a first inflatable portion when inflated; an inflator for providing an inflation force to the first inflatable cushion in accordance with a predetermined activation event; and a fluid dispersing conduit for providing the inflation force to the first inflatable cushion, the fluid dispersing conduit being in fluid communication with the first inflatable cushion and the inflator wherein the fluid dispersing conduit comprises a portion disposed between the inflator and the first inflatable cushion, wherein the portion provides a means for increasing an inflatable coverage of the airbag module by providing an area disposed between the first inflatable cushion and the inflator, wherein the area is capable of being converted into a diffuser opening for a second inflatable cushion, wherein the second inflatable cushion is inflated by the inflation force and the second inflatable cushion provides a second inflatable portion when inflated, the second inflatable portion being smaller than the first inflatable portion. Alternatively, the may be the same size of greater than the second portion.

In another exemplary embodiment a method of providing a side airbag module with an adaptable coverage area is disclosed. The method comprising: securing a first inflatable cushion to an inflator with a fluid dispersing conduit, the fluid dispersing conduit being secured to the inflator at one end and the first inflatable cushion at the other, wherein the fluid dispersing conduit comprises a portion disposed between the first inflatable cushion and the inflator, wherein the inflator provides an inflation force to the first inflatable cushion in accordance with a predetermined activation event; and extending a coverage area of the side airbag module by punching or piercing a plurality of diffuser openings in the portion of the fluid dispersing conduit and securing an inflation opening of a second inflatable cushion to the portion, wherein the inflation force inflates both the first inflatable cushion and the second inflatable cushion.

In another exemplary embodiment an airbag module for deploying an inflatable cushion along an interior side of a vehicle is provided. The airbag module comprising: an inflatable cushion comprising an upper edge portion; an inflator for providing an inflation force to the inflatable cushion in accordance with a predetermined activation event; a fluid dispersing conduit for providing the inflation force to the inflatable cushion, the fluid dispersing conduit being in fluid communication with the inflatable cushion and the inflator wherein the fluid dispersing conduit extends completely across and through the upper edge portion of the inflatable cushion, wherein a securing portion of the fluid dispersing conduit extends away from the first inflatable cushion at an end of the first inflatable cushion remote from the inflator and the securing portion allows the airbag module to be secured to the vehicle.

### BRIEF DESCRIPTION OF THE DRAWINGS

FIG. 1 is a side view of a portion of a vehicle interior having a pair of inflatable cushions and inflators;

FIG. 2 is a side view of a portion of a vehicle interior with an airbag module in accordance with an exemplary embodiment of the present invention;

FIG. 3 is a side view of a portion of a vehicle interior illustrating the deployment of an inflatable cushion in accordance with an exemplary embodiment of the present invention;

FIGS. 4A-4D are side views of a portion of a vehicle interior illustrating the deployment of an airbag module constructed in accordance with an exemplary embodiment of the present invention; and

FIG. 5 is a side view of a portion of a vehicle interior with an airbag module constructed in accordance with an alternative exemplary embodiment of the present invention.

### DETAILED DESCRIPTION OF EXEMPLARY EMBODIMENTS

The disclosure of the present application relates to a side airbag module. More particularly this application relates to a side airbag module that is adaptable to provide varying scopes of coverage along vehicle sides having various lengths and configurations. In addition, exemplary embodiments are directed to apparatus and methods to provide such side airbag modules, which are less expensive to manufacture than other methods and apparatus for providing coverage to vehicles having different configurations.

The fabric used for the inflatable cushions in side airbag modules is a significant portion of the total cost for the module. This is especially true for curtain airbags due to the large size of the cushion. It is further magnified on systems employing low-permeability fabrics and sealed seams that are required to provide longer inflation periods without increasing the size of the inflator or inflation force in order to provide these extended inflation periods. One piece woven constructions are desired due to their retention capabilities. An example of one such construction is found in U.S. Pat. No. 6,220,309 the contents of which are incorporated herein by reference thereto. However, for very large cushions the cost is again increased because it can be difficult to package several cushions side-by-side on the fabric roll for the required manufacturing processes.

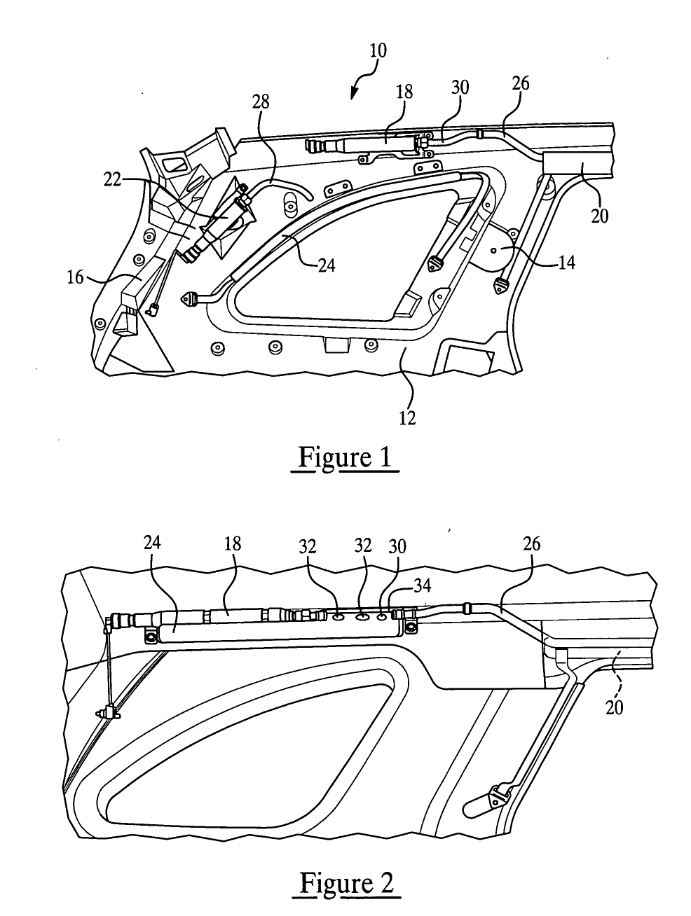

In order to provide coverage for vehicles having extended lengths (e.g., sports utility vehicles, station wagons, vans or minivans) while also limiting the associated cushion costs multiple inflator and inflatable cushion arrangements are contemplated. An example of one such configuration is illustrated in FIG. 1. Referring now to FIG. 1 a portion of a vehicle interior 10 is shown. In particular, a rear portion of a vehicle frame 12 is shown. Vehicle frame 12 comprises a plurality of pillars typically referred to as A-D pillars for extended length vehicles, wherein the A-pillar refers the forward vehicle portion and the D pillar refers to the rear vehicle portion and the B and C pillars refer to the frame portions disposed about the vehicle door openings. In FIG. 1, a C-pillar 14 and a D-pillar 16 are illustrated.

FIG. 1 illustrates one contemplated solution to provide extended side airbag coverage without incurring the costs of providing a large inflatable cushion. However, and in this embodiment a first inflator 18 and associated first inflatable cushion 20 is provided to provide coverage from the A-C pillar while a second inflator 22 and associated second inflatable cushion 24 is provided.

In this embodiment the first inflatable cushion is stored along the roof frame traversing from the A-C pillars and the associated inflator is disposed along the roof rail frame wherein a conduit 26 provides a means for providing an inflation force to the inflatable cushion. As illustrated, the second inflatable cushion is stored along the periphery of the window frame disposed between the C and D pillars and the associated inflator is disposed on the vehicle frame wherein a conduit 28 provides a means for providing an inflation force to inflatable cushion 24. Some challenges associated with this solution occur due to the fact that the inflator 22 and the cushion 24 are located underneath an interior vehicle trim (not shown) wherein there is very little available space underneath the vehicle trim and the diffuser tube may travel adjacent to the vehicle frame.

In order to simplify this construction and provide two separate inflatable cushions in order to reduce the cushion material cost a single inflator would be used and the gas would be delivered to the second inflatable cushion using a portion of the diffuser tube located between the first inflatable cushion and the second inflatable cushion. In this embodiment the diffuser tube provides an area for securement of an inflation opening of the second inflatable cushion. This embodiment is illustrated in FIG. 2.

Referring now to FIG. 2, an exemplary side airbag module is illustrated. Here a single inflator 18 is provided to release an inflation force to both the first inflatable cushion and the second inflatable cushion during a predetermined activation event.

The inflator, in accordance with technologies known to those skilled in the art, will provide an inflation output to an inflation opening of the inflatable cushion via a fluid dispersing conduit. In accordance with an exemplary embodiment, fluid dispersing conduit comprises rigid tubing such as a PVC pipe or metal pipe or conduit. The fluid dispersing conduit will comprise a fluid inlet that provides fluid communication between an outlet opening of the inflator and fluid dispersing conduit. It is, of course, understood and as applications may vary, the positioning of the inflator may be located in other positions than those illustrated in the drawings. For example, the inflator may be located in a forward vehicle position. Thus, the presented location is provided as an exemplary example and the present invention is not intended to be limited by the same. In yet another alternative, the inflator may be remotely located and a conduit or other fluid providing means is used to supply the inflating gas from the inflator to the inflatable cushion.

In accordance with an exemplary embodiment a portion 30 of the diffuser tube secured to the first inflatable cushion is provided with a plurality of diffuser openings 32 so that an inflation opening 34 of second inflatable cushion 24 can be secured about the portion wherein the inflation force of the inflator can inflate both the first inflatable cushion and the second inflatable cushion. Accordingly, and in this exemplary embodiment the packing for a side airbag module comprising a single inflator and the first inflatable cushion and the second inflatable cushion will comprise a packing that is similar to that of the packing required for the configuration illustrated in FIG. 1.

In addition to the material savings of the FIG. 2 embodiment, exemplary embodiments of the present invention provide other benefits. For certain vehicles, such as trucks, numerous body styles are offered and each style may require a curtain airbag of a unique configuration. Exemplary embodiments of the present invention allow the curtain designed for such vehicles to be adaptable. For example, an airbag module providing an A to C pillar curtain for one body style can be easily converted to an A to D pillar coverage by adding a second curtain using the methods and apparatus of exemplary embodiment of the present invention. A non-limiting example of this process would be to first provide inflator 18 and cushion 20 for one vehicle configuration (A-C pillar) and thereafter extend this coverage to a vehicle having an A-D pillar arrangement wherein cushion 24 is secured to portion 30 after a plurality of diffuser openings are disposed into portion 30 by for example a punching or piercing process. In one embodiment, the diffuser tube or conduit may be long enough to provide area 30 or alternatively a second diffuser portion may be secured between diffuser 28 and inflator 18 in order to provide area 30. Moreover, second diffuser portion can have the diffuser openings pre-punched into the second diffuser.

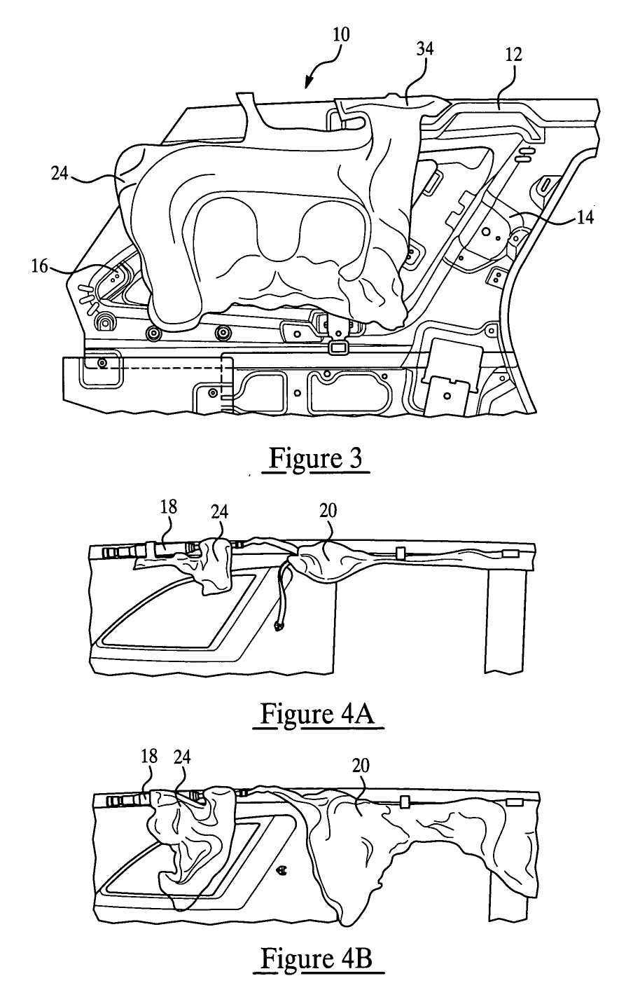

Referring now to FIG. 3, deployment of the second inflatable cushion in accordance with an exemplary embodiment of the present invention is illustrated. As illustrated, second inflatable cushion 24 is manufactured and constructed in order to traverse from the C pillar to a D pillar of the vehicle. In this embodiment, the second inflatable cushion deploys downward from the roof rail position through the interior interfaces to obtain window coverage. It is, of course, understood that second inflatable cushion 24 is configurable to cover other arrangements (e.g., A pillar to B pillar, A pillar to C pillar and B pillar to C pillar etc.) depending, of course, on the configuration and/or coverage of the first inflatable cushion. In one exemplary embodiment separate cushion sections are manufactured for assembly into various configurations for use in various vehicles having numerous size configurations while using a single inflator for providing a single source of inflation.

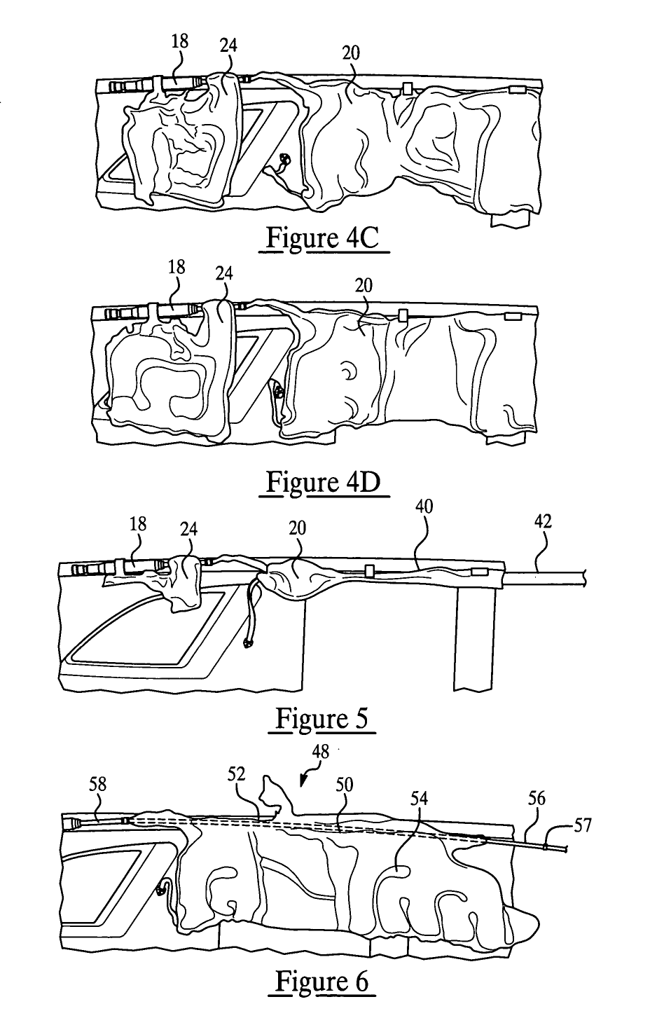

Referring now to FIGS. 4A-4D a deployment sequence of an exemplary embodiment of the present invention is illustrated. As illustrated the first and second inflatable cushions are configured to deploy in discrete areas of the vehicle frame.

In accordance with an alternative exemplary embodiment and referring now to FIG. 5 the diffuser tube is configured to have an extended length, which allows the same to traverse completely across an upper periphery 40 of first inflatable cushion 20 wherein a portion 42 passes completely through the cushion on a side of the inflatable cushion opposite to the location of the inflator. In this embodiment portion 42 is, of course, provided with no inflation openings and the portion is secured to the vehicle frame by for example using clamps, bolts or other features for securing portion 42 and the side airbag module to the vehicle frame.

Referring now to FIG. 6 and in accordance with another alternative exemplary embodiment another configuration of a side airbag module is illustrated. In this embodiment a side airbag module 48 is provided wherein a diffuser tube 50 is configured to have an extended length, which allows the same to traverse completely across an upper periphery 52 of an inflatable cushion 54 wherein a portion 56 of the diffuser tube passes completely through the cushion on a side of the inflatable cushion opposite to the location of an inflator 58. In accordance with an exemplary embodiment diffuser tube 50 may be a rigid tube having a contour to match its securement to the vehicle frame or diffuser tube 50 may be flexible to match the contour of the vehicle frame. In yet another alternative, diffuser tube 50 may comprise both rigid and flexible sections secured to each other by for example a clamp or other equivalent device. In one non-limiting embodiment, portion 56 is secured to the vehicle frame by a clamp 57 and bolts or any other equivalent means. In this embodiment a single inflator and single inflatable cushion are provided and the portion extending out from the inflatable cushion opposite to the location of the inflator provides a portion that can be secured to the vehicle frame in order to assist in the mounting of the airbag module to the vehicle.

In order to provide a robust securement about the conduits a securement means is provided to secure a portion of the inflatable sections about the conduit. A non-limiting example of the securement means is a band clamp. Other contemplated means include, adhesives and/or welding techniques.

In addition, the configurations of the first inflatable cushion and second inflatable cushion allow the same to be manufactured in separate manufacturing steps, which allows for modular construction of the airbag module.

It is also understood that the configuration of the inflatable cushions may vary and the illustrations of the cushion in the Figures are provided as examples and the present invention is not intended to be limited to the specific configurations provided in the figures, as they are considered ancillary to the present invention.

Moreover, the present invention is contemplated for use with numerous other vehicle configurations. For example, the vehicle may include three rows of seats; such vehicles include but are not limited to sports utility vehicles, station wagons, vans or minivans. Conversely, the vehicle may comprise only a single row of seats such vehicles include but are not limited to sports coups.

A non-limiting example of the inflatable sections of an inflatable cushion of exemplary embodiments of the present invention are constructed from all-woven inflatable fabrics which comprise areas of two layers and attachment points or “seams” where single layers of fabric are formed. Such single fabric layers are constructed solely through the utilization of a type of basket weave patterns. These specific single fabric layers provide a relatively effective manner of reducing air permeability within the entire fabric article by decreasing the possibility of yarn shifting upon inflation of the inflatable fabric. A teaching of such an inflatable cushion is found in U.S. Pat. No. 6,220,309 the contents of which are incorporated herein by reference thereto.

The inflatable cushion may also be made of any suitable airbag material for holding gas. In an exemplary embodiment, the inflatable cushion comprises two sheets of woven nylon fabric lined with urethane or other substantially impervious material such as silicone. The two urethane coated nylon sheets are secured to one another along an outer periphery thereof to define the overall inflatable section shape.

Prior to deployment, the inflatable cushion is stored in a compartment mounted to the roof rail or proximate to the roof rail. In order to store the airbag into the compartment the un-inflated inflatable cushions are folded into configurations which allows it to occupy small discrete areas within the vehicle interior. In accordance with exemplary embodiments of the present invention, the inflatable cushion is folded by a machine in order to provide the configurations disclosed herein. It is also possible to fold the inflatable cushion by hand.

When a predetermined activation event or occurrence is detected, the inflatable cushion is inflated by gas from the inflator. In general, the inflator will receive an inflation or deployment signal that causes the inflator to generate an inflation gas or inflation output for inflating the inflatable cushion. In an exemplary embodiment, the deployment signal is generated by a controller, such as a microcontroller of a sensing and diagnostic module configured for use with the airbag module. The sensing and diagnostic module receives a plurality of signals from appropriate sensing devices (e.g., door mounted accelerometers), and will generate a deployment signal if a predetermined activation event has been sensed.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. An airbag module for deploying an inflatable cushion along an interior side of a vehicle, the airbag module comprising:
a first inflatable cushion providing a first inflatable portion when inflated;
an inflator for providing an inflation force to the first inflatable cushion in accordance with a predetermined activation event; and
a fluid dispersing conduit for providing the inflation force to the first inflatable cushion, the fluid dispersing conduit being in fluid communication with the first inflatable cushion and the inflator wherein the fluid dispersing conduit comprises a portion disposed between the inflator and the first inflatable cushion, wherein the portion provides a means for increasing an inflatable coverage of the airbag module by providing an area disposed between the first inflatable cushion and the inflator, wherein the area is capable of being converted into a diffuser opening for a second inflatable cushion, wherein the second inflatable cushion is inflated by the inflation force and the second inflatable cushion provides a second inflatable portion when inflated, the second inflatable portion being smaller than the first inflatable portion.

2. The airbag module as in claim 1, wherein the fluid dispersing conduit is a rigid member.

3. The airbag module as in claim 1, wherein the fluid dispersing conduit extends completely across and through a top periphery of both the first inflatable cushion and the second inflatable cushion, wherein a securing portion of the fluid dispersing conduit extends away from the first inflatable cushion at an end of the first inflatable cushion remote from the inflator.

4. The airbag module as in claim 3, wherein the wherein the securing portion provides a means for securing the airbag module to a vehicle frame.

5. The airbag module as in claim 4, wherein the fluid dispersing conduit is a rigid member.

6. The airbag module as in claim 1, wherein the first inflatable cushion is configured to cover an area extending from an A pillar to a C pillar of a vehicle and the second inflatable cushion is configured to cover an area extending from the C pillar to a D pillar of the vehicle.

7. The airbag module as in claim 6, wherein the fluid dispersing conduit extends completely across and through a top periphery of both the first inflatable cushion and the second inflatable cushion, wherein a securing portion of the fluid dispersing conduit extends away from the first inflatable cushion at an end of the first inflatable cushion remote from the inflator.

8. The airbag module as in claim 7, wherein the wherein the securing portion provides a means for securing the airbag module to a vehicle frame and the fluid dispersing conduit is a rigid member.

9. The airbag module as in claim 1, wherein the first inflatable cushion is configured to cover an area extending from an A pillar to a B pillar of a vehicle and the second inflatable cushion is configured to cover an area extending from the B pillar to a D pillar of the vehicle.

10. The airbag module as in claim 9, wherein the fluid dispersing conduit extends completely across and through a top periphery of both the first inflatable cushion and the second inflatable cushion, wherein a securing portion of the fluid dispersing conduit extends away from the first inflatable cushion at an end of the first inflatable cushion remote from the inflator.

11. The airbag module as in claim 10, wherein the securing portion provides a means for securing the airbag module to a vehicle frame and the fluid dispersing conduit is a rigid member.

12. A method of providing a side airbag module with an adaptable coverage area, the method comprising:
securing a first inflatable cushion to an inflator with a fluid dispersing conduit, the fluid dispersing conduit being secured to the inflator at one end and the first inflatable cushion at the other, wherein the fluid dispersing conduit comprises a portion disposed between the first inflatable cushion and the inflator, wherein the inflator provides an inflation force to the first inflatable cushion in accordance with a predetermined activation event; and
extending a coverage area of the side airbag module by providing a plurality of diffuser openings in the portion of the fluid dispersing conduit and securing an inflation opening of a second inflatable cushion to the portion, wherein the inflation force inflates both the first inflatable cushion and the second inflatable cushion.

13. The method as in claim 12, wherein the fluid dispersing conduit is a rigid member and the diffuser openings in the portion are provided by punching or piercing of the portion.

14. The method as in claim 12, wherein the fluid dispersing conduit extends completely across and through a top periphery of both the first inflatable cushion and the second inflatable cushion, wherein a securing portion of the fluid dispersing conduit extends away from the first inflatable cushion at an end of the first inflatable cushion remote from the inflator.

15. The method as in claim 14, wherein the securing portion provides a means for securing the airbag module to a vehicle frame.

16. The method as in claim 15, wherein the fluid dispersing conduit is a rigid member.

17. The method as in claim 12, wherein the first inflatable cushion is configured to cover an area extending from an A pillar to a C pillar of a vehicle and the second inflatable cushion is configured to cover an area extending from the C pillar to a D pillar of the vehicle.

18. A side airbag module constructed in accordance with the method of claim 17.

19. The method as in claim 17, wherein the fluid dispersing conduit extends completely across and through a top periphery of both the first inflatable cushion and the second inflatable cushion, wherein a securing portion of the fluid dispersing conduit extends away from the first inflatable cushion at an end of the first inflatable cushion remote from the inflator.

20. A side airbag module constructed in accordance with the method of claim 19.

21. The method as in claim 19, wherein the wherein the securing portion provides a means for securing the airbag module to a vehicle frame and the fluid dispersing conduit is a rigid member.

22. The method as in claim 12, wherein the first inflatable cushion is configured to cover an area extending from an A pillar to a B pillar of a vehicle and the second inflatable cushion is configured to cover an area extending from the B pillar to a D pillar of the vehicle.

23. The method as in claim 22, wherein the fluid dispersing conduit extends completely across and through a top periphery of both the first inflatable cushion and the second inflatable cushion, wherein a securing portion of the fluid dispersing conduit extends away from the first inflatable cushion at an end of the first inflatable cushion remote from the inflator and the securing portion provides a means for securing the airbag module to a vehicle frame and the fluid dispersing conduit is a rigid member.

24. A side airbag module constructed in accordance with the method of claim 12.

25. An airbag module for deploying an inflatable cushion along an interior side of a vehicle, the airbag module comprising:
an inflatable cushion comprising an upper edge portion;
an inflator for providing an inflation force to the inflatable cushion in accordance with a predetermined activation event;
a fluid dispersing conduit for providing the inflation force to the inflatable cushion, the fluid dispersing conduit being in fluid communication with the inflatable cushion and the inflator wherein the fluid dispersing conduit extends completely across and through the upper edge portion of the inflatable cushion, wherein a securing portion of the fluid dispersing conduit extends away from the first inflatable cushion at an end of the first inflatable cushion remote from the inflator and the securing portion allows the airbag module to be secured to the vehicle.
